(19) United States
(12) Patent Application Publication
(10) Pub. No.: US 2006/0278170 A1
(43) Pub. Date: Dec. 14, 2006

(54) Method for removing unwanted animals and their attractants

(75) Inventors: Steve DeMoor, Sanford, FL (US); Christian Agnew, Mt. Juliet, TN (US)

Correspondence Address: Michael L. Leetzow, Esq.;Michael L. Leetzow, P.A., 5213 SHORELINE CIRCLE, SANFORD, FL, 32771, US

(73) Assignee: Wildlife Solutions, Inc.

(21) Appl. No.: 11/149,872

(22) Filed: Jun. 10, 2005

(51) Int. Cl. A01K 29/00

(52) U.S. Cl. 119/161

(57) ABSTRACT

A method for removing animals and the attractants left by those animals that may attract others animals to the same area is disclosed. The method includes removing the animals and cleaning up all of the organic material left by the animals so that other animals are not attracted to the same location. An organic matter neutralizing mixture is applied to the locations visited by the animals to eliminate any attractants left by the animals.

The present invention relates to a method for removing animals and the attractants left by those animals that may attract others animals to the same area, and more particularly, a method for removing the animals and cleaning up all of the organic material left by the animals so that other animals are not attracted to the same location.

There are prior art methods and products used to eliminate the waste products and the resultant odors left by domestic animals. However, these methods and products are directed to a different problem and solution than the present solution. The prior art methods and products are directed to eliminate the odors, but not prevent the domestic animals from revisiting the treated areas. Typically, the domestic animals will return to the treated area and, in fact, the owners do not want to prevent them from returning to the treated areas. The owners of the domestic animals only want to eliminate the undesirable behavior (and the resultant odors) that occurred in the treated area.

Other prior art methods to eliminate animals include removing the animals, putting the animals in a different locale and repairing any damage done in the area or the structure. However, different animals (typically, of the same type) would revisit the same area shortly thereafter.

Accordingly, the present invention is directed to a method that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to a method of eliminating at least one unwanted animal from a predetermined location, the method including the steps of identifying a predetermined area, the predetermined area including the predetermined location and being larger in area than the predetermined location, the at least one unwanted animal having traveled through at least a portion of the predetermined area to visit the predetermined location, preparing the predetermined area and predetermined location, and neutralizing organic matter from the at least one unwanted animal in the predetermined area and predetermined location with a bacteria-containing mixture to digest any organic matter left by the at least one unwanted animal.

In another aspect, the invention provides for method of eliminating at least one unwanted animal from a nesting area in a predetermined location including the steps of identifying a predetermined area, the predetermined area including the nesting area and being larger in area than the predetermined location, the at least one unwanted animal having traveled through at least a portion of the predetermined area to visit the nesting area, preparing the predetermined area and nesting area, and neutralizing organic matter from the at least one unwanted animal in the predetermined area and nesting area in the predetermined location with a bacteria-containing mixture to digest any organic matter left by the at least one unwanted animal.

In yet another aspect, the invention is directed to a method for eliminating at least one unwanted animal from a structure including the steps of identifying entry points into a structure used by the at least one unwanted animal, sealing the identified entry points into the structure, removing the at least one unwanted animal from the structure if present, removing any debris left by the at least one unwanted animal from the structure, and neutralizing any organic matter from the at least one unwanted animal in the structure with a bacteria-containing mixture to digest any organic matter left by the at least one unwanted animal.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a perspective view showing the entry points into a structure and the areas used by the animals to gain entry to the structure;

FIG. 2 is a partial cut-away view of a portion of the structure in FIG. 1, illustrating a nesting or other visited area;

FIG. 3 is an plan view of a portion of the structure illustrating the areas to be treated using the method according to the present invention;

FIG. 4 illustrates a nesting area and a hole under a structure made by an animal;

FIG. 5 illustrates the same area of FIG. 4 having been repaired using a method according to the present invention;

FIG. 6 is a flowchart illustrating one embodiment of a method according to the present invention; and

FIG. 7 is a flowchart illustrating a second embodiment of a method according to the present invention.

### DETAILED DESCRIPTION OF THE INVENTION

Animals, especially wild animals, are known to gain access to houses, office buildings, sheds, and other structures to nest, escape from other animals, bear offspring, or escape the weather. The owner of the structure is typically not accepting of the cohabitation by the animals and usually wants the animals removed from the structures. Even if the animals are captured and relocated and the access is blocked or eliminated, animals (which may or may not be the same animals or the same type of animal) typically find their way back into the structures.

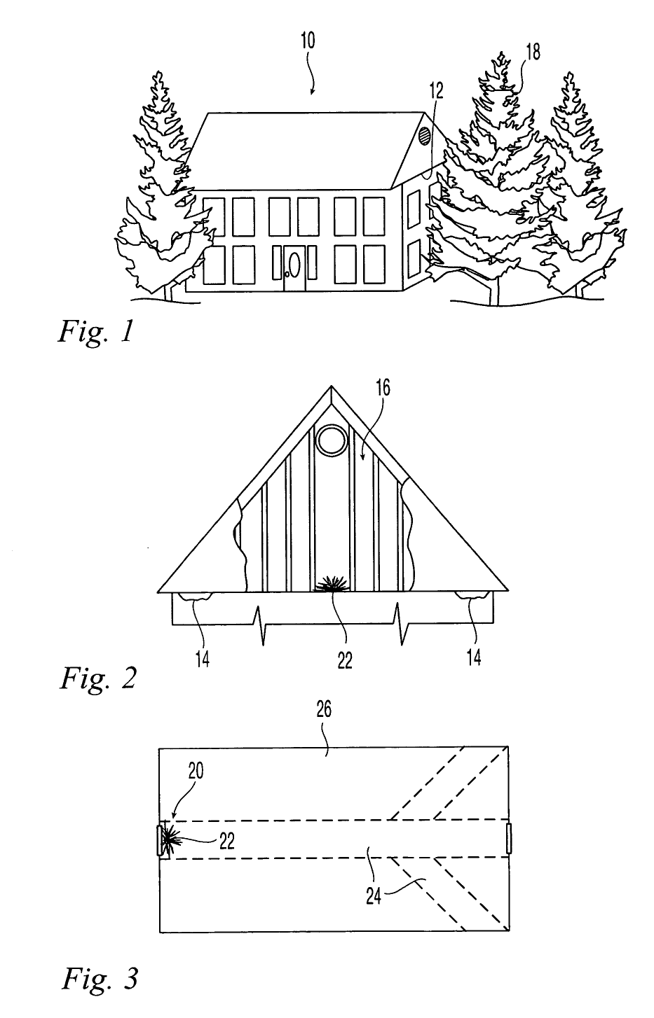

A house 10 as shown in FIG. 1 is one of the typical structures in which the animals will visit. The unwanted animal (not shown) will typically gain access to the house 10 through the eaves 12. Usually, the animal will chew or dig access points 14, which are illustrated as holes in FIG. 2, in the eaves 12 to gain access to the attic or in other locations to gain access to some other interior space 16. While a house 10 is illustrated as the structure in the figures, the present invention is not limited to a house, but could also be an office building, a utility shed, office building, an apartment, or any other structure that can provide shelter and protection to the animal. Similarly, while the holes 14 are illustrated in the eaves 12, the access points 14 could be located in any location in the structure 10 that would be easy for the animal to gain access. For example, if the house 10 were close to a tree, bush or shrub 18, the animal may use the tree, bush or shrub to locate an easy way into the structure 10 through an existing hole, the eaves, a vent, etc.

After gaining access to the structure 10, the animal would then typically settle in a location 20. The animal would typically bring in nesting materials 22 or other debris, which may include food, parasites, other animals, their young, etc. In order to get to location 20, the animal would travel along path 24, which generally leads from the access points 14. The path 24 may not be a single path as illustrated in FIG. 3, but multiple paths and the paths may not be well defined. Rather the animal or other creature may investigate along the way to the location 20 or investigate several areas before settling in at the location 20. In investigating for the location, the animal will have visited a larger area 26, which in this case would be the attic 16 of the house 10. While the animals are nesting and investigating within the structure 10, they leave behind scents from excrement, sexual pheromones, gland secretions, body oils, etc. Some of the scents left behind may be intentional as to mark the territory or to communicate with other animals, some may be left as attractants and others may be accidental. However, these scents attract other animals to same location. In fact, it has been discovered that even once the animal that first nested in the house 10 has been removed and the access points repaired, other similar animals will discover or create new access points or even reopen the old access points 14 to gain access to the location 20. This happens even if the nesting materials and all visible signs of the prior animal are removed and the location cleaned. It has been determined that the scents left behind in a non-visible manner attract the other animals to come back to the same area 26, if not the same location 20. Therefore, the scents left behind (i.e., body oil, urine, pheromones, secretions, etc.) have to be eliminated so as not to attract the other animals and have recurring unwanted animals.

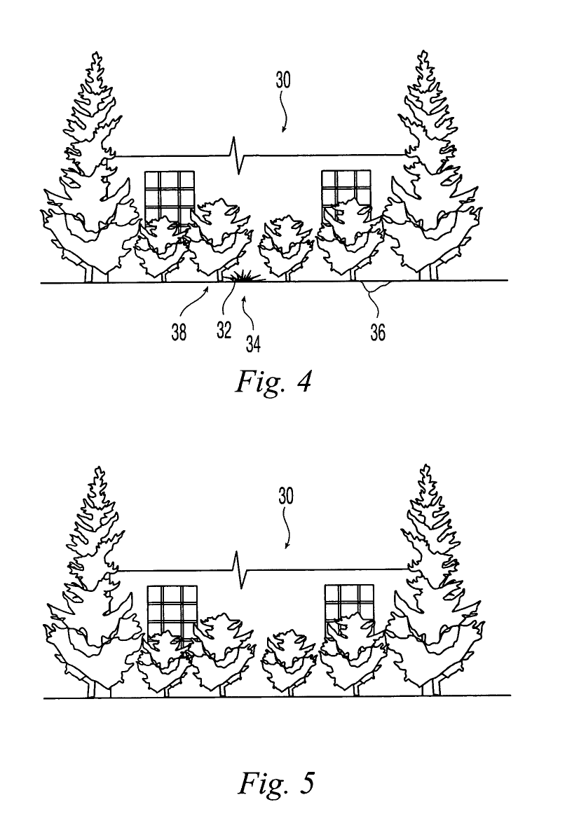

It has also been determined that similar behavior occurs on the outside of structures and not just on the inside. FIG. 4 illustrates a portion of a structure 30 that also has an unwanted animal visiting the area. Illustrated are nesting materials 32 left by the unwanted animal at a location 34 and a hole 36 that has been burrowed into the ground by an animal near and/or under structure 30. In the case of the nesting materials, the unwanted animal may have relocated materials from the area or simply rearranged loose materials from the surroundings. Again, the unwanted animal has most likely investigated the areas 38 around the structure 30 before settling on the location 34 near the structure. As with the inside locations discussed above, the animal will have left debris and scents on the bushes, shrubs, trees, structure, and ground. Again, removal of the nesting materials 32 and returning the area 38 and location 34 to its previsited condition will not eliminate the attractants left by the animal.

If the animal burrows a hole 36 near and/or under the structure 30, any debris left in and around the hole 36 can be removed and the hole 36 filled. Again, it has been found that unless the attractants (scents) are removed and/or eliminated, animals will return and dig a new hole in the same location or close to the same location 34.

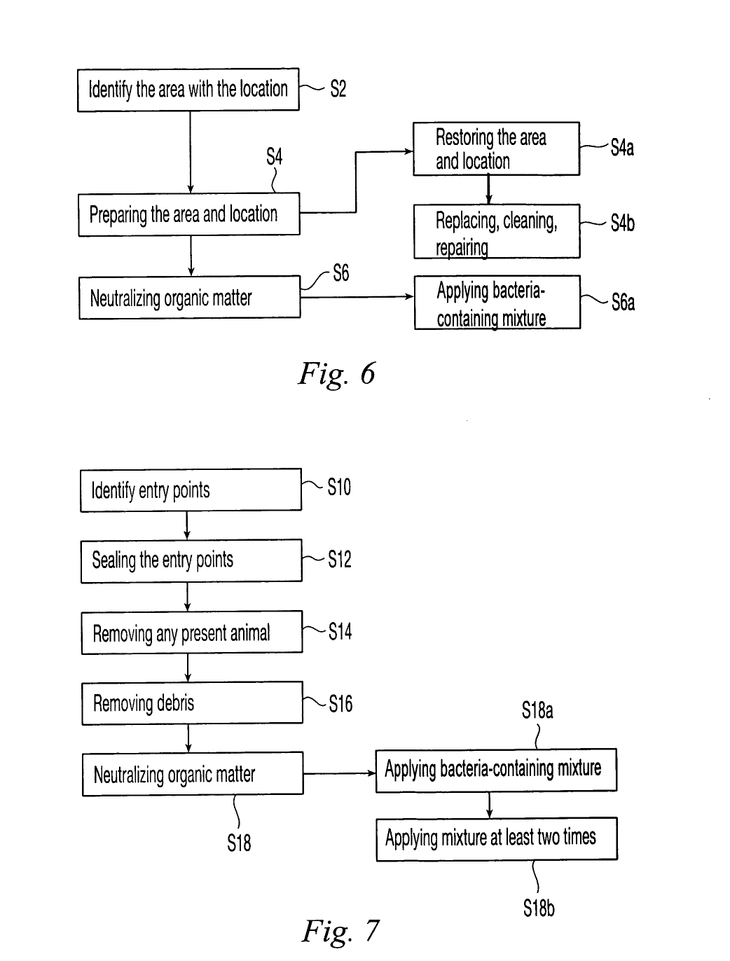

Therefore, in order to eliminate the attractants that cause the animals to return, one embodiment of a method, as illustrated in FIG. 6, to eliminate the animal from the location 20, 34, 36 includes identifying the area 26,38 where the animal has visited on the way to the locations 20, 34, 36. See Step S2. The area of visitation 26,38 by the animal is typically larger than the location since the animal looks around and has to travel to and from the location. The paths the animals take may differ when the animal approaches and leaves the location. If the animal is present at the location or in the area, the animal should first be safely removed to another location, the removal preferably being done by a professional. The area and location is then prepared at step S4. Preparation of the area and location may include restoring the location and area to a previsited condition or at least as close as possible as illustrated at substep S4a. Restoration may include removing any debris left by the animal. The debris removed may include any nesting materials, any excrement left by the animal, food, or other materials that were not present before the animal began visiting the area and location. As shown in substep S4b, restoration would also include repairing any damage done by the animal to or around the structure, including, for example, repairing holes, replacing any materials removed or destroyed by the animal, filling holes dug by the animal, replacing any plant materials, preventative maintenance on at-risk-areas, etc. Restoration may also include cleaning the area 26,38 (i.e., washing the area, scrubbing the walls, etc.). Then, as shown in step S6, the method includes neutralizing the organic matter left by the animal. The organic materials include excrement, sexual pheromones, gland secretions, body oils, etc. and the resultant scents or odors left by the animal. As shown in substep S6a, an application of a neutralizing material would then be applied to the area 26,38 and the location 20,34,36 to eliminate the scents that were left by the animal. The preferred neutralizing material is ANI-BAN™, available from Wildlife Solutions, Inc. the assignee of the present application. The neutralizing material includes bacteria that are capable of digesting the organic matter left by the animal. In the preferred embodiment, the bacteria are in Munox® XL Plus-DN available from Osprey Biotechnics, but any digesting bacteria would fall within the scope of the present invention. The neutralizing material is preferably applied in a liquid form to allow penetration of the neutralizing materials in the area and to gain access to the material and debris left by the animal. The mixture is preferably applied once, but more preferably applied at least two times. The mixture also preferable contains a fragrance to help mask the scents and odors left by the animals. Applicants have determined that mulberry is the preferable scent to use, although any appropriate scent could be used, if any is desired. Since the mixture is preferably a liquid, it is best applied using a sprayer to cover the area and the location. However, other methods, including spot treatments, are also within the scope of the present invention.

FIG. 7 illustrates another embodiment of a method according to the present invention. The illustrated method is more typical when the animal is removed from house or other building. In step S10, the entry or access point(s) 14 into the structure are identified. Those access points are then sealed at step S12. This may include a simple patch or a more elaborate construction project to return the access point(s) to their original condition. If there is an animal still located in the structure, the animal is removed at step S14. It is possible that the animal be removed (Step S14) before the entry or access points are sealed (Step S12), but it may be easier to capture the animal if the access points are sealed. Any debris left by the animal, as in the method described above, is removed from the area and location at step S16. After the debris is removed, any remaining organic matter is then neutralized at Step S18. The step of neutralizing the organic matter may preferably includes the substeps of applying an bacteria-containing mixture as illustrated in substep S18a and it may further include the substep of applying the bacteria containing mixture at least two times in substep S18b.

It will be apparent to those skilled in the art that various modifications and variations can be made in the methods for eliminating at least one unwanted animal of the present invention without departing from the spirit or scope of the invention. Thus, it is intended that the present invention cover the modifications and variations of this invention provided they come within the scope of the appended claims and their equivalents.

We claim:

1. A method of eliminating at least one unwanted animal from a predetermined location comprising the steps of:
identifying a predetermined area, the predetermined area including the predetermined location and being larger in area than the predetermined location, the at least one unwanted animal having traveled through at least a portion of the predetermined area to visit the predetermined location;
preparing the predetermined area and predetermined location; and
neutralizing organic matter from the at least one unwanted animal in the predetermined area and predetermined location with a bacteria-containing mixture to digest any organic matter left by the at least one unwanted animal.

2. The method of eliminating the at least one unwanted animal of claim 1, wherein the bacteria-containing mixture contains a fragrance.

3. The method of eliminating the at least one unwanted animal of claim 1, wherein the bacteria-containing mixture is a liquid.

4. The method of eliminating the at least one unwanted animal of claim 1, wherein the step of neutralizing organic matter includes applying the bacteria-containing mixture to digest any organic matter left by the at least one unwanted animal only one time.

5. The method of eliminating the at least one unwanted animal of claim 1, wherein the step of neutralizing organic matter includes applying the bacteria-containing mixture to digest any organic matter left by the at least one unwanted animal at least two times.

6. The method of eliminating the at least one unwanted animal of claim 1, wherein the step of preparing the predetermined area and predetermined location includes restoring the predetermined area and location to a previsited condition.

7. The method of eliminating the at least one unwanted animal of claim 6, wherein restoring the area to a previstited condition includes performing at least one task from the group of replacing materials disturbed by the at least one unwanted animal, cleaning up organic matter left by the at least one unwanted animal, and repairing a structure altered by the at least one unwanted animal.

8. The method of eliminating the at least one unwanted animal of claim 1, wherein the predetermined location includes a nest.

9. A method of eliminating at least one unwanted animal from a nesting area in a predetermined location comprising the steps of:
identifying a predetermined area, the predetermined area including the nesting area and being larger in area than the predetermined location, the at least one unwanted animal having traveled through at least a portion of the predetermined area to visit the nesting area;
preparing the predetermined area and nesting area; and
neutralizing organic matter from the at least one unwanted animal in the predetermined area and nesting area in the predetermined location with a bacteria-containing mixture to digest any organic matter left by the at least one unwanted animal.

10. A method for eliminating at least one unwanted animal from a structure comprising the steps of:
identifying entry points into a structure used by the at least one unwanted animal;
sealing the identified entry points into the structure;
removing the at least one unwanted animal from the structure if present;
removing any debris left by the at least one unwanted animal from the structure; and
neutralizing any organic matter from the at least one unwanted animal in the structure with a bacteria-containing mixture to digest any organic matter left by the at least one unwanted animal.

11. The method of eliminating the at least one unwanted animal of claim 10, further comprising the step of neutralizing any organic matter from the at least one unwanted animal outside the structure with a bacteria-containing mixture to digest any organic matter left by the at least one unwanted animal.

12. The method of eliminating the at least one unwanted animal of claim 10, wherein the mixture contains a fragrance.

13. The method of eliminating the at least one unwanted animal of claim 10, wherein the mixture is a liquid.

14. The method of eliminating the at least one unwanted animal of claim 10, wherein the structure is a house.

15. The method of eliminating the at least one unwanted animal of claim 10, wherein the step of neutralizing organic matter includes applying the bacteria-containing mixture to digest any organic matter left by the at least one unwanted animal only one time.

16. The method of eliminating the at least one unwanted animal of claim 10, wherein the step of neutralizing organic matter includes applying the bacteria-containing mixture to digest any organic matter left by the at least one unwanted animal at least two times.

17. The method of eliminating the at least one unwanted animal of claim 10, wherein the bacteria-containing mixture is applied to locations where the at least one unwanted animal had access within the structure.

18. The method of eliminating the at least one unwanted animal of claim 10, wherein the step of removing the at least one unwanted animal from the structure precedes the step of sealing the identified entry points into the structure.
